(19) United States
(12) Patent Application Publication
(10) Pub. No.: US 2020/0360209 A1
(43) Pub. Date: Nov. 19, 2020

(54) HOSPITAL BED DRAWSHEET ADJUSTER SYSTEM, DEVICE, AND KIT

(71) Applicant: BILLMART LLC, New York, NY (US)

(72) Inventors: WILLIAM LEMBECK, New York, NY (US); MARTIN MANDELBAUM, Port Jefferson, NY (US)

(73) Assignee: BILLMART LLC, New York, NY (US)

(21) Appl. No.: 16/877,381

(22) Filed: May 18, 2020

Related U.S. Application Data
(60) Provisional application No. 62/848,895, filed on May 16, 2019.

(51) Int. Cl. A61G 7/05

(52) U.S. Cl. CPC A61G 7/0502; A61G 7/015

(57) ABSTRACT

A system, device, and kit for repositioning a patient reposed on a bed including a housing configured to be mounted at a head of a bedframe; at least one roller supported by said housing; a flexible member is coupled to said at least one roller; a retracting head coupled to the flexible member, rotation of the at least one roller in a first direction effecting spooling of the cable onto the at least one roller and translation of the retracting head toward the head of the bed, the retracting head including a mouth section; and a clamp, the clamp being rotatably coupled to the mouth section and being configured to releasably secure a drawsheet positioned on the bed within the mouth section, the clamp having an edge having a corresponding shape to a first surface of the mouth section such that the shape of the edge approximates the shape of the first surface of the mouth section when the clamp is rotated toward a locked condition in which the drawsheet is releasably secured within the mouth section.

### CROSS REFERENCE TO RELATED APPLICATIONS

This application makes reference to, and claims priority from, U.S. Prov. Ser. No. 62/848,895 filed May 16, 2019, the entire contents of which are incorporated herein by reference.

### FIGURE SELECTED FOR PUBLICATION

FIG. 3.

### BACKGROUND OF THE INVENTION

### Field of the Invention

The present disclosure generally relates to systems, devices, and kits to facilitate the repositioning of bedridden patients on a bed.

### Description of the Related Art

Conventionally, a manual drawsheet is positioned under bedridden patients between the patient and the bed on which the patient is lying. Repositioning of the patient typically involves a minimum of two or more people pulling on the drawsheet so as to lift and slide the patient in the desired direction, often back to the head of the bed after the patient has drifted down the bed.

Repositioning the patient is a very labor-intensive process requiring a great deal of strength on the part of the two people pulling on the drawsheet. Sometimes, the drawsheet may bunch up under the patient (who themselves may be bunched with folded legs) requiring that even more effort be exerted to retrieve the drawsheet from under the patient who may lack bodily control (e.g., may be paralyzed, have nerve damage etc. or otherwise incapable of assisting in his repositioning).

The present inventors have recognized a need for systems and devices that can facilitate the repositioning of bedridden patients to minimize the number of people required to perform such an activity, the strength required to perform the repositioning, and to minimize the discomfort to the patient being repositioned.

The background section is provided to more fully explain the advantages provided by the presently disclosed invention and to explain the problems that it addresses. Nothing in the background section should be construed as prior art unless otherwise explicitly stated.

### ASPECTS AND SUMMARY OF THE INVENTION

According to one or more aspects of the present invention, there is provided a system, device, and kit for repositioning a patient reposed on a bed may include a housing configured to be mounted at a head of a bedframe; at least one roller supported by said housing; a cable, web, string, rope or other flexible member is coupled to said at least one roller; a retracting head coupled to said cable, rotation of the at least one roller in a first direction effecting spooling of the cable onto the at least one roller and translation of the retracting head toward the head of the bed, the retracting head including a mouth section; and a clamp, the clamp being rotatably coupled to the mouth section and being configured to releasably secure a drawsheet positioned on the bed within the mouth section, the clamp having an edge having a corresponding shape to a first surface of the mouth section such that the shape of the edge approximates the shape of the first surface of the mouth section when the clamp is rotated toward a locked condition in which the drawsheet is releasably secured within the mouth section.

The clamp may exert a force uniformly upon a width of the drawsheet, thereby minimizing the potential of damage to the drawsheet insofar as stress concentrations are minimized as a result.

The device may further include an actuator for rotating the at least one roller, actuation of the at least one roller effecting retraction of the retracting head toward the head of the bed and locking of the clamp with respect to the mouth section. As a force applied to the cable in the first direction is increased, the clamp may exert a greater force upon the first surface of the mouth section.

According to another aspect of the present invention there is provided a bending restraint system or mechanism that restrains a bending of a frame during use of the proposed system, method, and kit.

The above and other aspects, features, and advantages of the present invention will become apparent from the following description read in conjunction with the accompanying drawings in which like reference numerals designate the same elements.

### BRIEF DESCRIPTION OF THE DRAWINGS

A further understanding of the present invention can be obtained by reference to a preferred embodiment set forth in the illustrations of the accompanying drawings. The drawings are not intended to limit the scope of this invention, which is set forth with particularity in the claims as appended or as subsequently amended, but merely to clarify and exemplify the invention. Reference is now made to the following drawings in which:

FIG. 1 is a front view of a patient on a conventional drawsheet shown in use, in a bunched-up state, as a patient rests upon the drawsheet upon an inclined hospital bed.

FIG. 1B is a top view of the drawsheet of FIG. 1 shown in an unbunched, unfurled state.

FIG. 2 is a perspective view of the conventional drawsheet of FIG. 1 shown in use when then the hospital bed is in a fully reclined position.

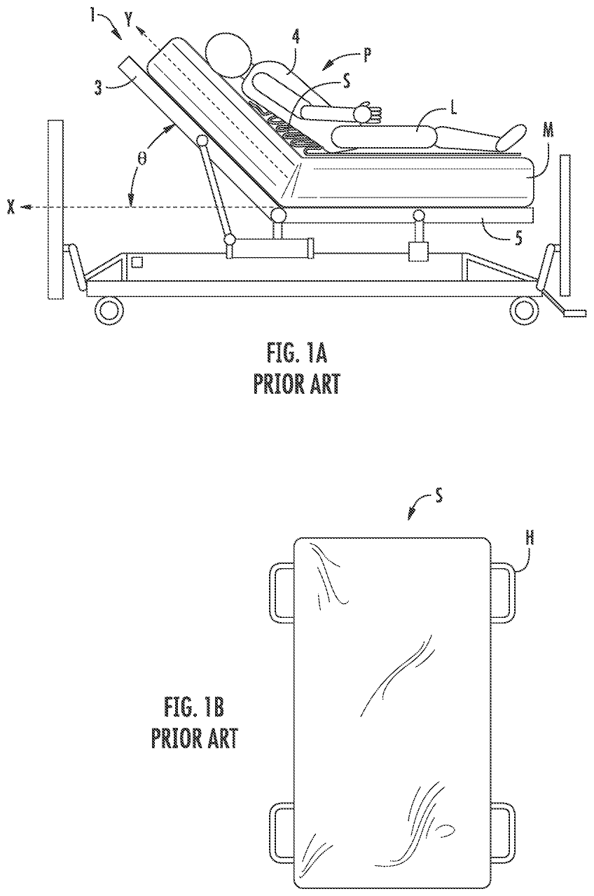

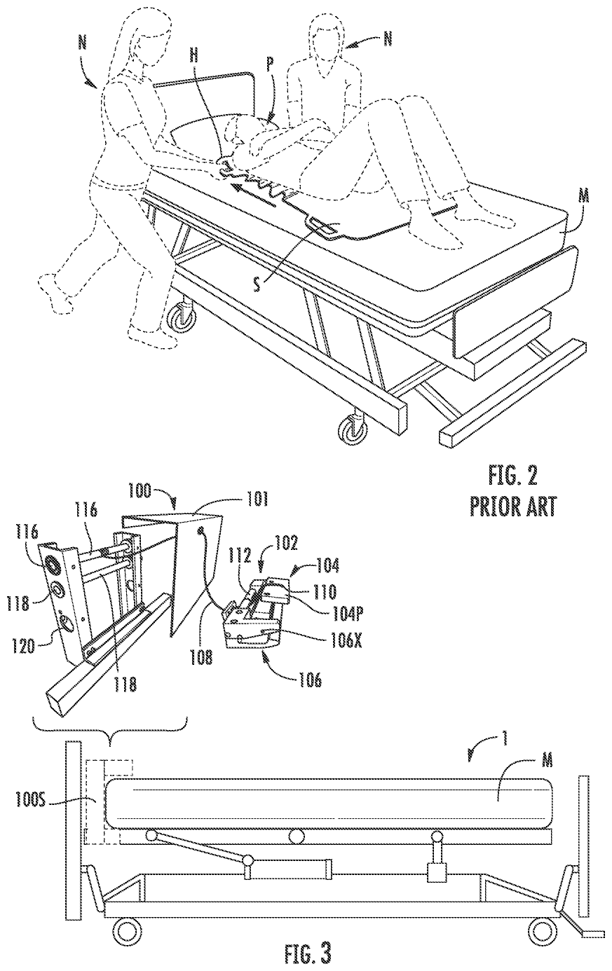

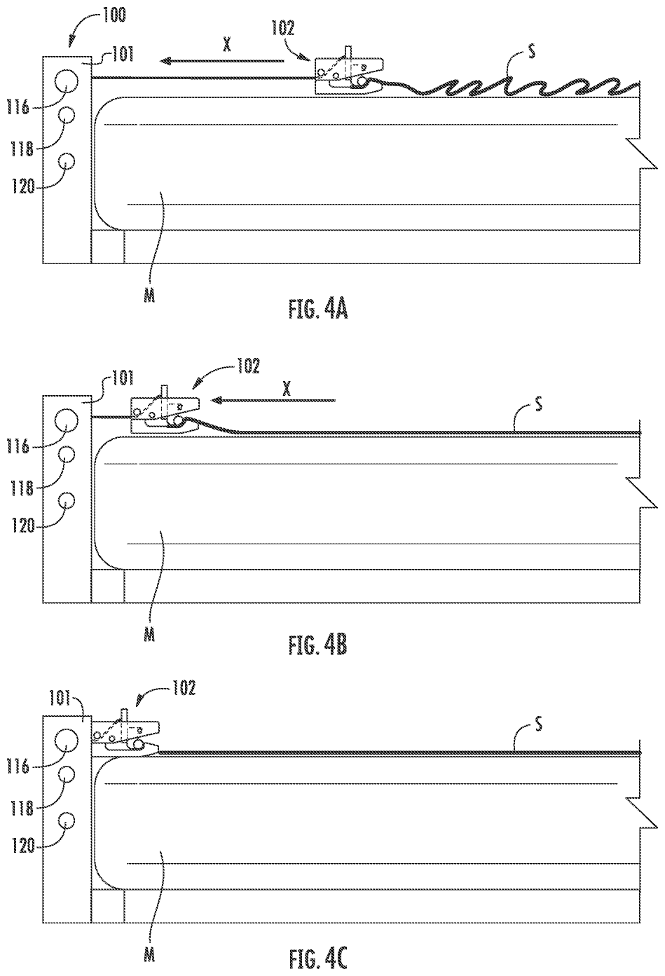

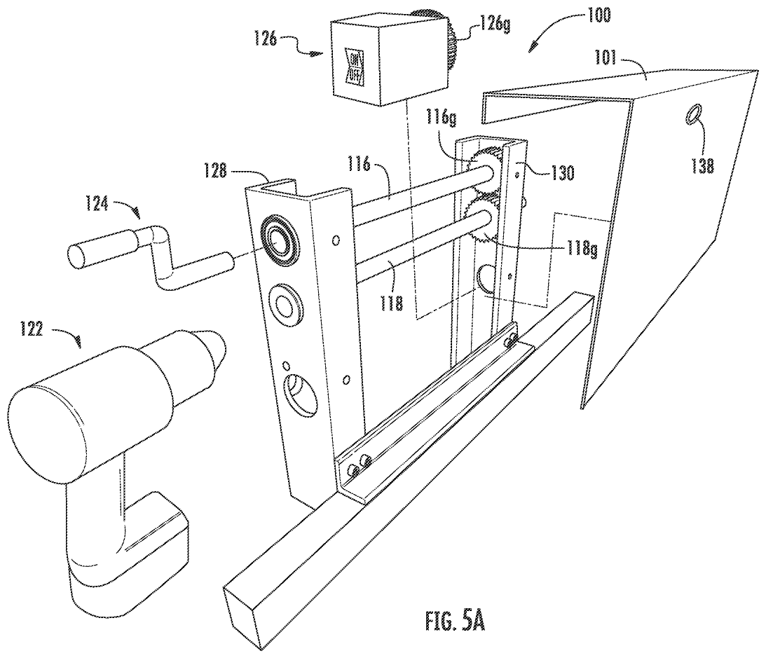

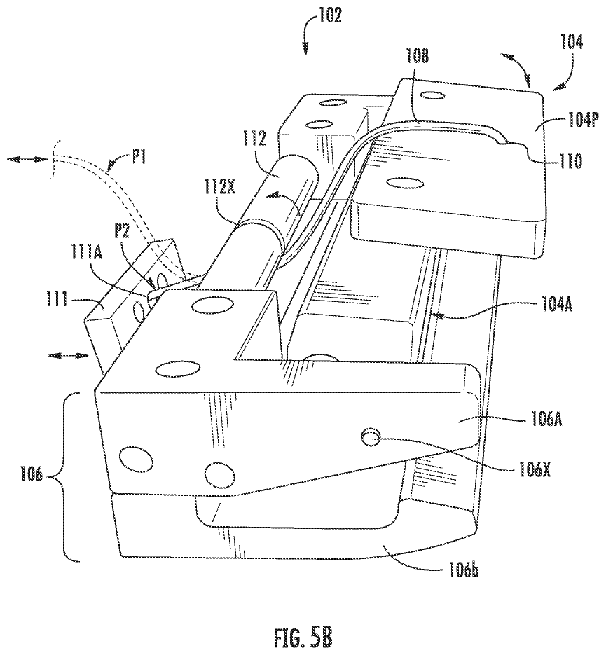

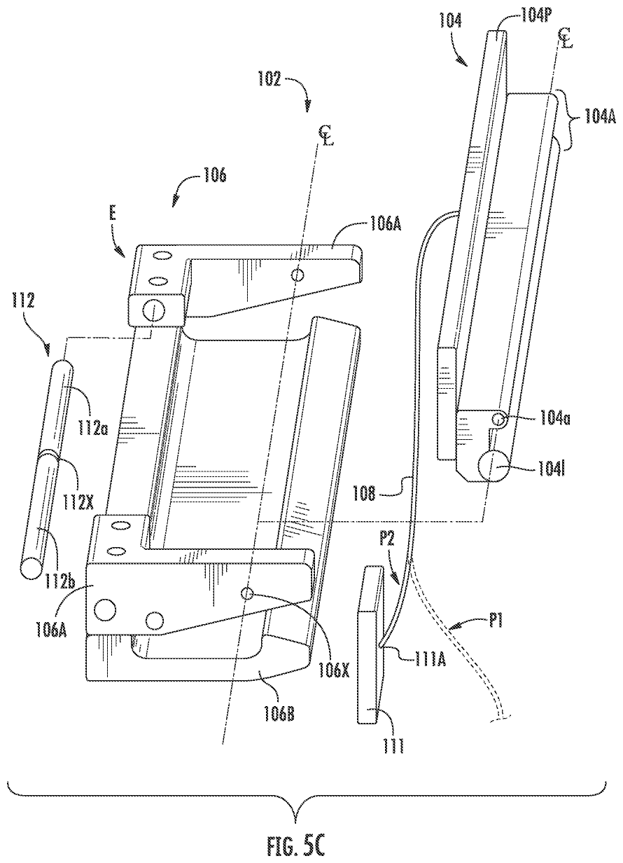

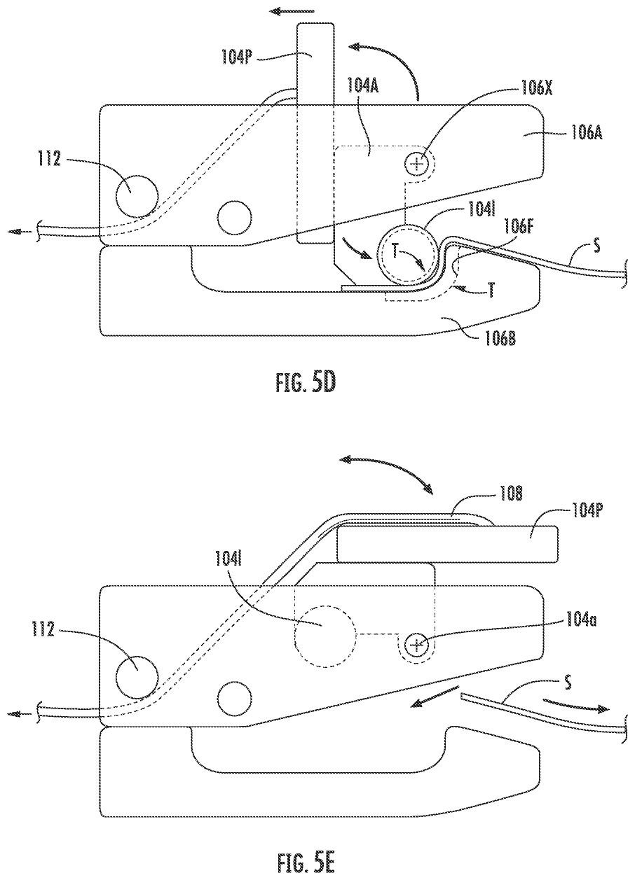

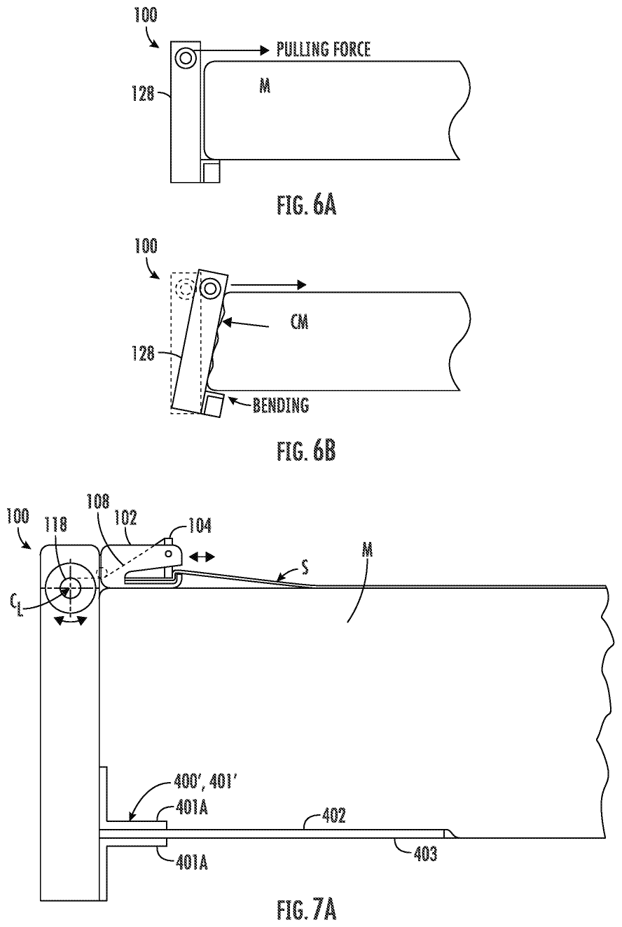

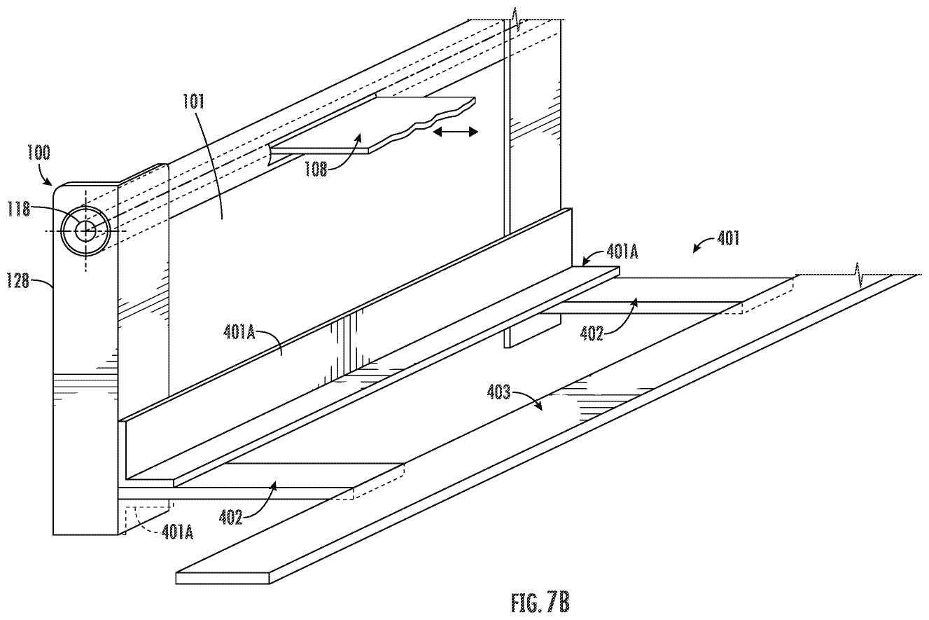

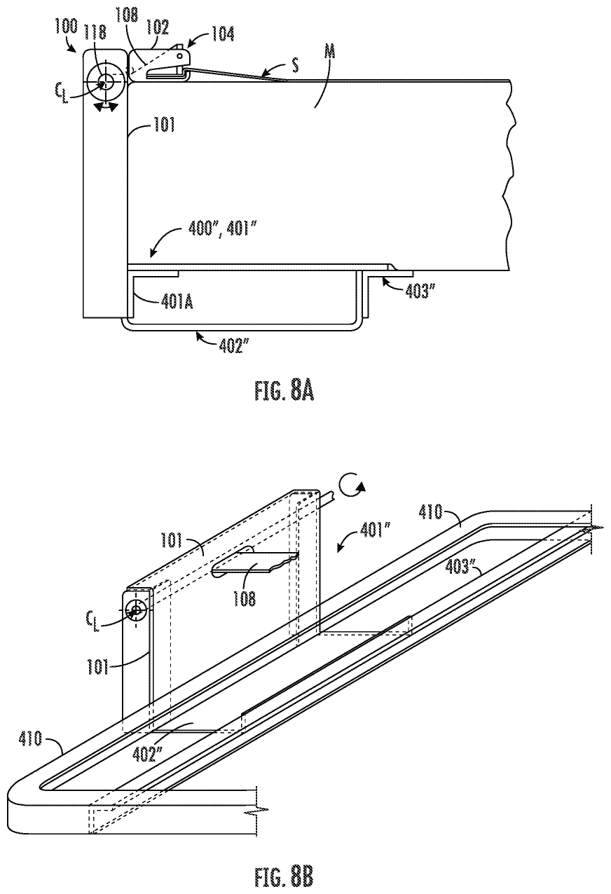

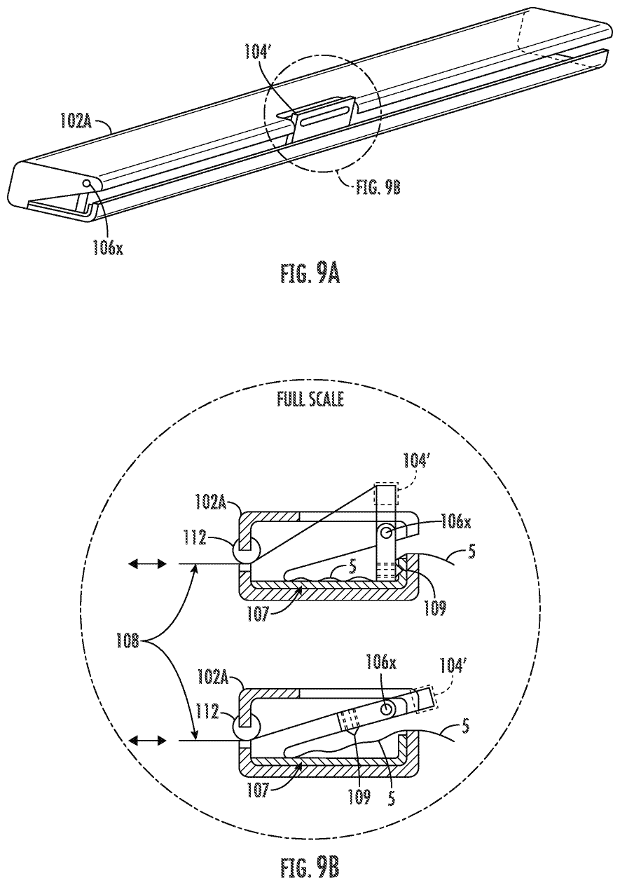

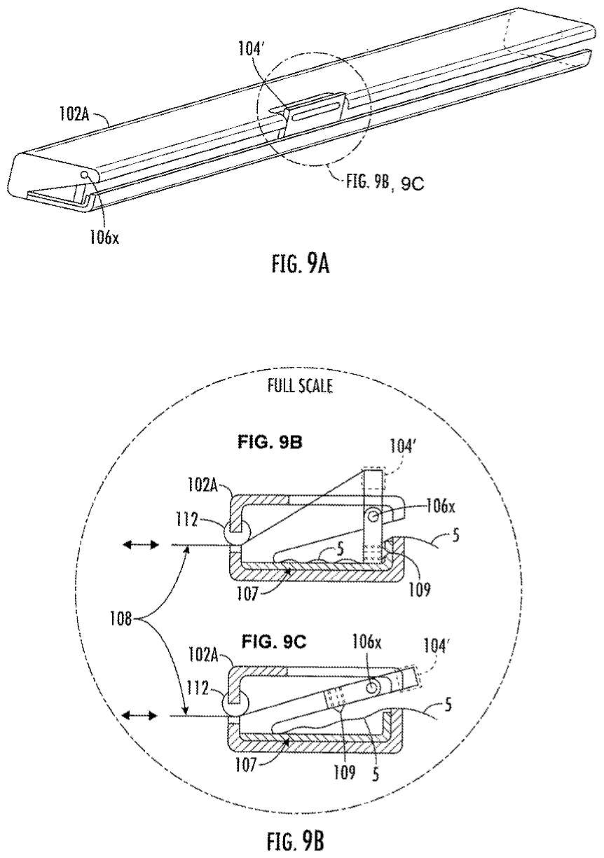

FIG. 3 is a perspective view of a drawsheet adjuster system according to the present disclosure shown relative to the conventional hospital bed of FIG. 1.

FIGS. 4A-4C are front views of the drawsheet adjuster system of FIG. 3 shown in use.

FIG. 5A is an exploded view of partial aspects of the proposed drawsheet adjuster system of FIG. 3 shown relative to several actuator devices.

FIG. 5B is a further partial perspective view of a drawsheet adjuster device of the drawsheet adjuster system of FIG. 3 and for link to FIG. 5B via the pull P1/P2 of the flexible member, according to the present disclosure.

FIG. 5C is a partial perspective exploded view of the drawsheet adjuster device of FIG. 5B.

FIG. 5D is a front side view of the drawsheet adjuster device of FIG. 5B shown in an actuated state grasping a drawsheet during an engagement when flexible member is under tension.

FIG. 5E is a front view of the drawsheet adjuster device of FIG. 5B shown in an unactuated state shown prior to insertion of a drawsheet prior to the flexible member being under tension and drawing the pivot member into the engagement position.

FIGS. 6A, 6B provide illustrative views of bending results on a mattress to reach a crumpled mattress state.

FIGS. 7A and 7B provide further illustrative views of an alternative and adaptive bending restraint system according to one aspect of the present invention.

FIGS. 8A and 8B provide further illustrative views of an alternative and adaptive bending restraint system according to a further aspect of the present invention.

FIGS. 9A, 9B. and 9C provide further illustrative perspective (FIG. 9A) and partial sectional views (FIGS. 9B, 9C) of an alternative extended retraction head according to a further aspect of the present invention.

### DETAILED DESCRIPTION OF THE PREFERRED EMBODIMENTS

Reference will now be made in detail to an illustrative embodiment of the present invention as illustrated in the accompanying drawings. Wherever possible, same or similar reference numerals are used in the drawings and the description to refer to the same or like parts or steps. The drawings are simplified in form and are not to precise scale. For the purposes of clarity only, directional terms, such as top, bottom, up, down, over, above, below, etc., or motional terms, such as forward, back, sideways, transverse, etc. or motional terms such as forward, back, sideways, transverse, etc. may be used with respect to the drawings. These and similar directional terms should not construed as limiting the scope of the invention in any manner.

It should be understood that the techniques, systems, compositions, and operating structures in accordance with the present disclosure may be embodied in a wide variety of sizes, shapes, forms and modes, some of which may be quite different from those in the disclosed embodiment. Consequently, the specific structural and functional details disclosed herein are merely representative, yet in that regard, are deemed to afford the best embodiment for purposes of disclosure and to provide a basis for the claims herein which define the scope of the present invention.

As shown in FIG. 1A, a hospital bed 1 including a pneumatically controlled frame including a backrest portion 3 configured to support the back of a patient P and a leg portion 5 configured to support the legs of the patient P. As shown in FIG. 1A, a longitudinal axis X extends along the length of the leg portion 5 and a longitudinal axis Y extends along the length of the backrest portion 3. An angle θ is defined between the axes X and Y and may be adjusted so as to elevate the back of the patient P such that the upper body U of the patient is raised relative to the lower portion L of the patient's body. A mattress M placed upon the frame of the bedframe may be foldable or otherwise bendable formed from a flexible foam material.

A conventional drawsheet S (best shown in FIG. 1B) may bunch up under the patient P. As shown in FIG. 1B, the drawsheet S may bunch up under the patient P when raising or elevating the backrest portion 3 of the bedframe relative to the leg portion 5 of the bedframe. As shown in FIG. 1B, the drawsheet S may optionally include handles H located near the four corners of the generally rectangular drawsheet S such that a nurse or assistant can grab ahold of the handles to pull upon them to move the drawsheet S and any patient resting on the drawsheet S in a desired direction to reposition the patient. Other drawsheets S common in the trade may not include handles rendering the process even more difficult. It is further noted as a detriment that the application of a force at a small area of the drawsheet S may result in a stress concentration at the application point of the force that can over time result in damage or tearing of the drawsheet S. It would be advantageous, as is currently disclosed, that the application of the drawing force be more uniformly applied to the drawsheet S to minimize any stress concentration upon the drawsheet S to prevent tearing and the like.

Referring again to FIG. 1A, when the patient P is resting with his back inclined relative to his legs, the drawsheet S may have a tendency to slide down the inclined back section of the mattress M and become bunched up behind the patient P. As bedridden patients are particularly prone to bedsores so that not only is a bunched-up bedsheet uncomfortable, but it can also result in damage to the skin and may even ultimately result in infections. Often as shown in FIG. 1A, the patient P slides down the length of the bed along with the now bunched up drawsheet S.

As shown in FIG. 2, two assistants or nurses N may then drag the drawstring S by pulling on opposing sides of the drawsheet S such that by applying a substantially equal amount of force on opposing sides of the drawsheet S toward the head of the mattress M, the patient will move in that direction, i.e., upward along axis Y. In contrast, if an unequal amount of force, i.e., if a force is applied to only one side of the drawsheet S, a rotational force may be imparted to the patient which would be the case if a single nurse attempted to reposition the patient P thereby greatly consuming a greater amount of force and time to effect the same repositioning of the patient.

As shown in FIGS. 3-5E, and beyond, a hospital bed drawsheet adjuster system 100 (see FIG. 3) is disclosed, which may be used in a method for adjusting the drawsheet and may be provided in a kit-form for attachment to a hospital bed end and frame as shown in FIGS. 3, 4A-5E and otherwise herein. The hospital bed drawsheet adjuster system 100 addresses at least some of the problems of the prior art shown in FIGS. 1A-2. Advantageously, the adjuster system 100 provides a more uniform grabbing of a length of material of the drawsheet S so that stress concentrations are minimized and requires far less physical strength to operate than would be required to pull on the drawsheet S by hand and can be operated by a single operator or nurse. As discussed above, In contrast, pulling on opposing sides of the drawsheet S upon its handles H would necessarily require at least two operators because of the physical dimensions, i.e., width, would make it impossible to simultaneously grasp opposing sides of the drawsheet S as doing so would be beyond one's typical arm reach even if one were strong enough to perform the task.

As shown in FIG. 3, the adjuster system 100 may be placed in a suitable space 100S at or near the head of the mattress M of otherwise conventional hospital bed 1. In so doing, the adjuster system 100 may be utilized to retrofit a conventional hospital bed 1 as opposed to necessitating the procurement of an entirely new hospital bed 1. While a hospital bed may be configured to have the adjuster system 100 integrated during its manufacture, retrofitting of an existing hospital bed may be desirable due to the lower costs. The adjuster system 100 may include a housing 101 which may be secured to the bedframe, preferably at the head of the hospital bed. The adjuster system 100 includes a retracting head 102 that is configured to clamp onto the drawsheet S and to pull the drawsheet S toward the housing 101 in a direction toward the head of the hospital bed 1.

During an exemplary, but non-limiting use, as shown in FIGS. 4A-4C, the retracting head 102 may clamp onto drawsheet S and pull it back to the head of the bed, thereby unfurling it from its bunched-up state to a substantially flat state on the surface of the mattress M, and if a patient is positioned on drawsheet S, additionally returning the patient to a normal position to benefit the patient and without causing undue stress on the health care provider. As shown in FIG. 4A, the retracting head 102 may be clamped onto the drawsheet S. The retracting head 102 is coupled to a string or a cable or webbing or other flexible member 108 which upon actuation of the adjuster system 100 exerts a force in direction X (extending orthogonally relative to a surface of the housing 101 and along the lengthwise direction of the mattress M when in the reclined state) toward the head of the bed until the drawsheet is in the desired position as shown in FIG. 4B. Thereafter, as shown in FIG. 4C, the retracting head 102 may be optionally uncoupled from the drawsheet S. Although shown as resting at or near the head of the bed atop the mattress M, in some implementations, the retracting head 102 may fully retract into housing 101 or may rotated upward to sit atop of the housing 101 away from the mattress M if more room is needed on the mattress surface. Alternatively, additional space between the housing 101 and the mattress M may be provided should the entire length of mattress be needed for the patient.

Referring back to FIG. 3, the retracting head 102 may include a clamp 104 that is configured to rotate relative to a mouth section 106. The cable 108 is configured to effect rotation of the clamp 104 relative to the mouth section 106 at pivot point 106x. The clamp 104 may include a plate 104P which may be coupled to the cable 108 at location 110 such that the application of a force upon the cable 108 effects both a pulling force on the entire retracting head 102 and to also effecting a rotating force of the clamp 104 relative to the mouth section 106; both the pulling and the rotating forces may occur at the same time. A roller portion 112 may be pivotally supported at a proximal end E of the retracting head 102 to help guide the cable 108 to prevent snagging or knotting of the cable 108. A plurality of rollers 116 and 118 may interact with one another to effect retraction or the pulling force upon the cable 108. In particular, the cable 108 may wrap around the roller 116 such that rotation in one direction of the roller 116 effects retraction of the cable 108 as more of the cable 108 wraps around the roller 118. Each of the rollers 116 and 118 may include a gear 116g, 118g, respectively, at respective ends thereof, that interact with one another such that rotation of one of the rollers 116, 118 effects a corresponding rotation of the other roller 116, 118. The gears 116g, 116h may include a pair of gears at opposing ends of the roller 116, 118, respectively. Access aperture 120 provides a location through which an actuator may be positioned for effecting rotation of the rollers 116, 118.

FIG. 5A illustrates the adjuster system 100 with parts separated shown relative to several different types of actuators that may be utilized for actuating the system 100 including for example, a hand crank 124 or an electric crank 122 that are configured to couple to an end of the roller 116 or 118 when supported by ends of the frame 128, 130. In particular, mounted within the housing 101 may be a frame including a first section 128 and a second section 130 that support the rollers 116 and 118 at opposing ends thereof. An electrical gear actuator 126 including a gear 126 may also be included within the frame to interact with at least one of the gears 116g or 118g effect desired rotation of the rollers 116, 118 and a pulling force upon the cable 108.

As shown in FIG. 5B, the retracting head 102 is shown in an unactuated condition in which the clamp 104 is rotated with respect to an upper portion 106A of the mouth section 106 away from a lower portion 106B of the mouth section 106. The upper portion 106B may be angled such that the space between the upper and lower sections 106A, 106B narrows toward the proximal end E of the retracting head 102. The cable 108 may pass through a channel 112x defined by section 112a and 112b of the roller portion 112. As shown best in FIG. 5C, cable 108 may be coupled to a plate 111, e.g., the cable 108 may be pass through an aperture 111A of the plate 111 and may be secured therein such that the cable 108 may not be removed therefrom. Manual operation of the cable 108 may be controlled by movement of the plate 111 when the cable 108 is secured thereto. Alternatively, the cable 108 may be coupled to one of the rollers 116 and 118 such that the length of the cable 108 that is free and not spooled around the roller 116 or 118 is determined by rotation of the roller 116 or 118 which would effect a corresponding movement of the retracting head 102.

Movement of the plate 111 may affect a clamping effect may bringing the clamp 104 to move in such a way that edge portion 104 contacts the lower portion 106B of the mouth section 106. It is noted that to inhibit damage to the drawsheet S, the lower portion 106B may include a surface 106F which may be a coating that is non-stick and substantially smooth such that the risk of damage to the drawsheet S is reduced.

Actuated states and unactuated states of the retracting head 102 will now be described with respect to FIGS. 5D and 5E, respectively. As shown in FIG. 5D, a pivot point 104a the clamp 104 may be rotated about pivot point 106x of the upper section 106A of the mouth section 106 and toward the lower section 106B of the mouth section 106 to clamp the drawsheet S between an edge portion 104b and the lower section 106B which may have shapes corresponding to one another. For example, the edge portion 104b may be rounded and may fit into a corresponding arcuate section of the lower section 106B. Movement of the clamp 104 in an opposite direction may affect release of the drawsheet S out from the mouth section 106.

Additionally, referring now to FIGS. 6A, 6B a further aspect of the present invention is recognized wherein the drawsheet system 100 is provided on a bedframe having a mattress (M) with a connection support as noted in FIGS. 3, 4A, 4B, 4C, and FIG. 5A, and is placed under a pulling force (see FIG. 6A). When a pulling force (shown) is applied under particularly high restraints for the drawsheet S (e.g., under a heavy load) a bending force is applied which may cause a crumpled mattress (CM) state, and if further or repeatedly bent, a system failure or dissatisfaction with the drawsheet system 100. As a result, a further aspect of the present invention is provided.

Additionally, referring now to the remaining figures, including FIGS. 7A, 7B, wherein one alternative and non-limiting aspect of a bending restraint system 400′ is provided in conjunction with the frame of a bed (FIG. 3) and a mattress M shown with claim 104 secured to bedsheet S. Bending restraint system 400 includes a bed frame engagement system 401, having braces 401A, 401A as shown. with one or a plurality of extending braces 402 engaging one or a plurality of cross braces 403 positioned under mattress (M) and which may be optionally secure to a bed frame by welding, threaded engagement, bracing or by other fixing and securing means. Alternatively, bending restraint system 400′ may be secured under mattress M only, but securing fixably to the bed frame (shown FIG. 3 or herein) provides further enhancements to restrain the pulling forces. FIG. 7B is provide following FIG. 7A without the mattress so that it can be appreciated that the cross brace(s) 403 span and extend the width of mattress M and any bed frame (FIG. 3 or later) so as to engage the bed frame and restrain system 100 from rotation during pulling operations to straighten drawsheet S. The frame engagement system 401 is provided with broad surfaces and members to allow ready welding, clamping, adhesive fixing, or other securing methods to a conventional bed frame, as will be understood by one of skill in the art; who will further appreciate, having studied the present invention, that the bending restraint system 400 maintains a generally perpendicular orientation between the system 100 and mattress M so that the crumpled mattress CM occurrence is prevented.

Referring additionally now to FIGS. 8A, 8B an alternative and adaptive bending restraint system 400″ is provided with a bed frame engagement system 401″ having one or more extending braces 402″, shown here as a continuous bent metal member 402″ extending from housing 101 having a bending restraint U-curve to reach below and mount to a selected bed frame engagement system 401″ to reach an extended cross brace 403″ that has a full length sufficient to engage a bed frame 410 (shown in exemplary frame-form only) and to be secured thereto by welding, bracing, clamping or other fixing means. As a result, any pulling force (FIG. 6A) is transmitted from the housing 101 through to the bending restraint system 400″ through engagement members 401A and extending brace 402″ to cross brace 403″ and held in a fixed arrangement during movement of the drawsheet S by flexible member 108.

Regarding bending restraint systems 400′, 400″ and related mechanisms and systems for restraining and preventing bending and resist the pulling force (FIGS. 6A, 6B): It will be recognized by those of skill in the art having studied the enclosed disclosure that modifications and variations of the force-transfer (e.g., bending restraint systems) systems may be appreciated without departing from the scope and spirit of the present invention.

Additionally, referring now to FIGS. 9A, 9B, and 9C further improvements to the retracting head are provided. An extended retracting head 102A is provided having a full-width arrangement for a full-width of a bedsheet S, which has a corresponding full length or extended length clamp 104′, which engages in the pressure manner as previously discussed herein above. Additionally, as noted in the partial cross-sectional views FIGS. 9B, 9C, there is an elastomeric member or elastomeric layer 107 proximate the gripping end of 104′ so as to provide an enhanced gripping strength. Further, a gripping and protruding boss 109 protrudes to provide a further gripping action with drawsheet S when pressed and urged into elastomeric layer 107. As will be understood by those of skill in the hart having studied the present disclosure, the above alternative aspects of the present embodiment enhance the gripping strength and retention force of the retraction head 102A as a further improvement of the present invention.

Having described at least one of the preferred embodiments of the present invention with reference to the accompanying drawings sufficient to enable one of ordinary skill in the art to practice the invention, and to provide the best mode of practicing the invention presently contemplated by the inventor, it is to be understood that such embodiments are merely exemplary and that the invention is not limited to those precise embodiments, and that various changes, modifications, and adaptations may be effected therein by one skilled in the art without departing from the scope or spirit of the invention as defined in the appended claims. Accordingly, the disclosed embodiments are not mutually exclusive combinations of features; rather, the invention may comprise a combination of different individual features selected from different individual embodiments, as understood by persons of ordinary skill in the art. The scope of the invention, therefore, shall be defined solely by the appended claims.

It will be recognized that as used herein a flexible member may be any form of flexible member sufficient to achieve the purpose set out for the structures herein, including in the form of a rope, a cable, a string, or other related item. It is further to be recognized by those of skill in the art that the present system may operate with multiple (more than one) flexible member so as to provide improved force separation and smooth operation.

Further, while there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like, it will be apparent to those of skill in the art that numerous changes may be made in such details without departing from the spirit and the principles of the invention. It should be appreciated that the present invention is capable of being embodied in other forms without departing from its essential characteristics.

### GLOSSARY OF REFERENCE CHARACTERS

1: hospital bed
3: bedframe upper section
5: bedframe lower section
θ: angle
x: lengthwise axis of the hospital bed
y: lengthwise axis of upper section of bedframe
p: patient
U: upper body
L: lower body
M: mattress
S: drawsheet
T: force between clamp 104 and contact surface 106F
H: handle of drawsheet
N: nurse
P1: a first position of string or cable or cable or flexible member 108 when not coupled to plate 111
P2: a second (alternative) position of string or cable or flexible member 108 when coupled to plate 111
100: adjuster system
100S: space for the adjuster system at head of the bed
101: housing
102, 102A: retracting head
104, 104′: clamp
104A: portion of the clamp 104
104a: pivoting section of the clamp 104 that is coupled to pivot point 106x
104b: edge of the clamp juxtaposing a corresponding surface of mouth section 106
104P: plate of the clamp
106: mouth section of the retracting head
106A: upper section of mouth section
106B: lower section of mouth section
106F: a contact surface which may be non-stick or smooth, for example
106x: pivot point
107: elastomeric lining
108: string or cable or webbing or flexible member
109: gripping boss
110: location string 108 attaches to the plate of the clamp 104P
111: plate
111A: aperture within plate 111
112: roller section
112a: portion of roller section 112
112b: portion of roller section 112
112x: channel within roller section 112
116: roller on which string 108 spools
118: roller
120: access aperture
122: electric actuator
124: hand crank
128: frame section supporting rollers 116, 118
130: frame section supporting rollers 116, 118
400′, 400″: bending restraint system
401: frame engagement system
401A: corner braces
402: extending brace(s)
403: cross brace(s)

What is claimed is:

1. A device, for repositioning a patient reposed on a bed having a bedframe, comprising:
a housing configured to be mounted at a head of said bedframe;
at least one roller supported by said housing;
a flexible member coupled to said at least one roller;
a retracting head coupled to said flexible member, rotation of the at least one roller in a first direction effecting spooling of the flexible member onto the at least one roller and translation of the retracting head toward the head of the bed, the retracting head comprising:
a mouth section;
a clamp, the clamp being rotatably coupled to the mouth section and being configured to releasably secure a drawsheet positioned on the bed within the mouth section, the clamp having an edge having a corresponding shape to a first surface of the mouth section such that the shape of the edge approximates the shape of the first surface of the mouth section when the clamp is rotated toward a locked condition in which the drawsheet is releasably secured within the mouth section; and
a bending restraint system configured to secure said housing to said bedframe and prevent a change in position of said housing relative to said bedframe during a use of said device.

2. The device of claim 1, further comprising: an actuator for rotating the at least one roller, actuation of the at least one roller effecting retraction of the retracting head toward the head of the bed and locking of the clamp with respect to the mouth section.

3. The device of claim 2, wherein: as a force applied to the flexible member in the first direction is increased, the clamp exerts a greater force upon the first surface of the mouth section.

4. The device of claim 1, wherein: the clamp exerts a force uniformly upon a width of the drawsheet.

5. A system, for repositioning a patient reposed on a bed having a bedframe and a headportion, comprising:
a housing configured to be mounted at the head portion of the bedframe;
at least one roller supported by said housing;
a flexible member coupled to said at least one roller;
a retracting head coupled to said flexible member, rotation of the at least one roller in a first direction effecting spooling of flexible member onto the at least one roller and translation of the retracting head toward the head of the bed, the retracting head comprising:
a mouth section;
a clamp, the clamp being rotatably coupled to the mouth section and being configured to releasably secure a drawsheet positioned on the bed within the mouth section, the clamp having an edge having a corresponding shape to a first surface of the mouth section such that the shape of the edge approximates the shape of the first surface of the mouth section when the clamp is rotated toward a locked condition in which the drawsheet is releasably secured within the mouth section; and
a bending restraint system configured to secure said housing to said bedframe and prevent a change in position of said housing relative to said bedframe during a use of said system.

6. The system of claim 5, further comprising: an actuator for rotating the at least one roller, actuation of the at least one roller effecting retraction of the retracting head toward the head of the bed and locking of the clamp with respect to the mouth section.

8. The device of claim 6, wherein: as a force applied to the cable in the first direction is increased, the clamp exerts a greater force upon the first surface of the mouth section.

9. The system of claim 5, wherein: the clamp exerts a force uniformly upon a width of the drawsheet.

10. A kit, for repositioning a patient reposed on a bed upon a drawsheet, comprising:
a device for repositioning a patient reposed on said bed, comprising:
a housing configured to be mounted at a head of a bedframe;
at least one roller supported by said housing;
a flexible member coupled to said at least one roller;
a retracting head coupled to said flexible member, rotation of the at least one roller in a first direction effecting spooling of the flexible member onto the at least one roller and translation of the retracting head toward the head of the bed, the retracting head comprising:
a mouth section;
a clamp, the clamp being rotatably coupled to the mouth section and being configured to releasably secure said drawsheet positioned on the bed within the mouth section, the clamp having an edge having a corresponding shape to a first surface of the mouth section such that the shape of the edge approximates the shape of the first surface of the mouth section when the clamp is rotated toward a locked condition in which the drawsheet is releasably secured within the mouth section;
an actuator for actuating the at least one roller;
a bending restraint system configured to secure said housing to said bedframe and prevent a change in position of said housing relative to said bedframe during a use of said device.

11. The kit, according to claim 10, wherein: the actuator is releasably coupled to the at least one roller.
